(19) United States
(12) Patent Application Publication
(10) Pub. No.: US 2021/0172748 A1
(43) Pub. Date: Jun. 10, 2021

(54) VISIT MANAGEMENT APPARATUS, VISIT MANAGEMENT METHOD AND VISIT MANAGEMENT SYSTEM

(71) Applicant: Honda Motor Co., Ltd., Tokyo (JP)

(72) Inventor: Takahiro Oyama, Tokyo (JP)

(21) Appl. No.: 17/263,803

(22) PCT Filed: Jul. 25, 2019
(86) PCT No.: PCT/JP2019/029206

§ 371 Date: Jan. 27, 2021

(30) Foreign Application Priority Data
Jul. 31, 2018 (JP) 2018-143780

(51) Int. Cl. G01C 21/34; G01C 21/36

(52) U.S. Cl. CPC G01C 21/3438; G01C 21/3492; G01C 21/3461; G01C 21/3605

(57) ABSTRACT

A visit management apparatus configured to manage assignment of a plurality of workers to visiting destinations, includes: a microprocessor and a memory coupled to the microprocessor. The microprocessor is configured to function as: a representative latitude/longitude calculation unit configured to calculate representative values of latitude and longitude of predetermined visiting destinations in a certain time slot for each of the plurality of pickup workers; an information acquisition unit configured to acquire order information for visiting an additional visiting destination other than the predetermined visiting destinations in the certain time slot; and a worker assignment unit configured to assign a worker to visit the additional visiting destination based on a comparison result between the representative values calculated by the representative latitude/longitude calculation unit and latitude and longitude of the additional visiting destination, when the order information for visiting the additional visiting destination is acquired by the information acquisition unit, wherein the representative latitude/longitude calculation unit is configured to calculate average values of latitude and longitude of the predetermined visiting destinations in the certain time slot as the representative values.

### CROSS-REFERENCE TO RELATED APPLICATION

This application is a National Stage of PCT international application Ser. No. PCT/JP2019/029206 filed on Jul. 25, 2019 which designates the United States, incorporated herein by reference, and which is based upon and claims the benefit of priority from Japanese Patent Application No. 2018-143780, filed on Jul. 31, 2018, the entire contents of which are incorporated herein by reference.

### TECHNICAL FIELD

This invention relates to a visit management user apparatus, a visit management method and a visit management system for managing assignment of workers in charge to visiting destinations.

### BACKGROUND ART

Conventionally, there has been known an apparatus which detects positional information of taxis by GPS, and, in response to an order from a user who wants to use the taxi, dispatch a taxi whose position detected by GPS is closest to the user from among vacant taxis (for example, Patent Document 1). In the apparatus of Patent Document 1, the taxi which may reach the user most efficiently is determined by selecting the taxi closest to the user based on the current position at the time or order reception.

### CITATION LIST

### Patent Literature

Patent Document 1: Japanese Unexamined Patent Publication No. 2007-172116

### DISCLOSURE OF INVENTION

### Problems to be Solved by the Invention

However, in the apparatus described in Patent Document 1, it is difficult to assign workers in charge who visit directed visiting destinations not right away, for example, in designated time slots, for example.

### Means for Solving Problem

An aspect of the present invention is a visit management apparatus configured to manage assignment of a plurality of workers to visiting destinations, including: a representative latitude/longitude calculation unit configured to calculate representative values of latitude and longitude of predetermined visiting destinations in a certain time slot for each of the plurality of workers; an information acquisition unit configured to acquire order information for visiting an additional visiting destination other than the predetermined visiting destinations in the certain time slot; and a worker assignment unit configured to assign a worker to visit the additional visiting destination based on a comparison result between the representative values calculated by the representative latitude/longitude calculation unit and latitude and longitude of the additional visiting destination, when the order information for visiting the additional visiting destination is acquired by the information acquisition unit. The representative latitude/longitude calculation unit is configured to calculate average values of latitude and longitude of the predetermined visiting destinations in the certain time slot as the representative values.

Another aspect of the present invention is a visit management method for managing assignment of a plurality of workers to visiting destinations, including: a representative latitude/longitude calculation step for calculating representative values of latitude and longitude of predetermined visiting destinations in a certain time slot for each of the plurality of workers; an order information acquisition step for acquiring order information for visiting an additional visiting destination other than the predetermined visiting destinations in the certain time slot; and a worker assignment step for assigning a worker to visit the additional visiting destination based on a comparison result between the representative values calculated in the representative latitude/longitude calculation step and latitude and longitude of the additional visiting destination, when the order information for visiting the additional visiting destination is acquired in the order information acquisition step. The representative latitude/longitude calculation step includes calculating average values of latitude and longitude of the predetermined visiting destinations in the certain time slot as the representative values.

Another aspect of the present invention is a visit management system, including: a management server configured to manage assignment of a plurality of workers to visiting destinations; and a plurality of portable terminals respectively carried by the plurality of workers. The management server includes: a representative latitude/longitude calculation unit configured to calculate representative values of latitude and longitude of predetermined visiting destinations in a certain time slot for each of the plurality of workers; an information acquisition unit configured to acquire order information for visiting an additional visiting destination other than the predetermined visiting destinations in the certain time slot; a worker assignment unit configured to assign a worker to visit the additional visiting destination based on a comparison result between the representative values calculated by the representative latitude/longitude calculation unit and latitude and longitude of the additional visiting destination, when the order information for visiting the additional visiting destination is acquired by the information acquisition unit; and a transmission unit configured to transmit a notification command to notify that the worker assigned by the worker assignment unit is to visit the additional visiting destination, to a portable terminal of the worker assigned by the worker assignment unit. The portable terminal includes: a notification unit configured to make notification in accordance with the notification command transmitted by the transmission unit. The representative latitude/longitude calculation unit is configured to calculate average values of latitude and longitude of the predetermined visiting destinations in the certain time slot as the representative values.

### Effect of the Invention

According to the present invention, it becomes possible to assign workers in charge who visit destinations in designated time slots efficiently.

### BRIEF DESCRIPTION OF DRAWINGS

FIG. 1 is a diagram showing an example of system configuration of a pickup management system according to an embodiment of the present invention.

FIG. 2 is a block diagram showing a schematic configuration of a pickup worker terminal in FIG. 1.

FIG. 3 is a block diagram showing a schematic configuration of the pickup management server in FIG. 1.

FIG. 4 is a conceptual diagram showing pickup destination information managed by the pickup management server in FIG. 3.

FIG. 5 is a conceptual diagram showing representative locations managed by the pickup management server in FIG. 3.

FIG. 6 is a flowchart showing an example of process performed by the pickup management server in FIG. 3.

FIG. 7 is a block diagram showing a schematic configuration of a manager terminal in FIG. 1.

FIG. 8 is a diagram showing an example of a pickup worker designation screen of the manager terminal in FIG. 7.

FIG. 9 is a diagram showing another example of the pickup worker designation screen of the manager terminal in FIG. 7.

### DESCRIPTION OF EMBODIMENT

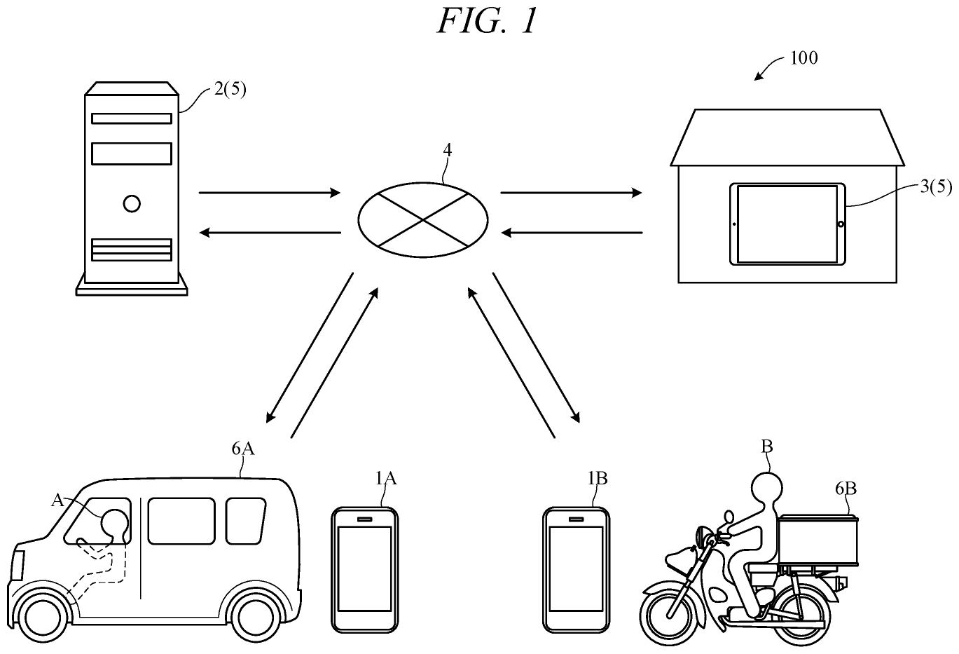

An embodiment of the present invention is explained with reference to FIG. 1 to FIG. 9 in the following. A visit management apparatus according to the embodiment of the present invention can be applied to visit management systems that manage workers in charge of visiting destinations, vehicles used for such visits, or the like, in various industries. Hereafter, an example will be described in which the present visit management apparatus is applied to a pickup management system in which the manager of the distribution center of a distribution business or post office that picks up and delivers cargoes receives a pickup order and assigns the pickup order to a pickup worker who is visiting pickup destinations. That is, an example will be described in which workers in charge of picking up cargoes at the distribution center of a distribution business, post office, or the like that picks up and delivers cargoes are regarded as persons in charge.

The types of pickup services provided by pickup workers include daily pickup in which cargoes are picked up at predetermined pickup destinations (daily pickup destinations) at predetermined times or in predetermined time slots and spot pickup in which cargoes are picked up on a one-shot basis, that is, at designated pickup destinations (spot pickup destinations) in designated time slots in accordance with pickup orders received on an ad hoc basis (spot pickup orders). The center manager who has received a spot pickup order at the distribution center has to efficiently select a pickup worker who will visit the spot pickup destination at a designated time slot, from the pickup workers who are visiting the daily pickup destinations. Conventionally, the manager selects such a pickup worker while relying on his or her experience. On the other hand, in order to allow even an inexperienced manager to efficiently select a pickup worker and to allow a pickup worker to be automatically selected if no manager is present at the distribution center, a pickup management apparatus according to the present embodiment is configured as follows.

### [Functional Configuration of Pickup Management System 100]

First, the function configuration of a pickup management system 100 according to the embodiment of the present invention will be described. FIG. 1 is a diagram showing an example of the configuration of the pickup management system 100. As shown in FIG. 1, the pickup management system 100 includes multiple (two in FIG. 1) pickup worker terminals 1A and 1B, a pickup management server 2, and a manager terminal 3 that are connected through a network 4 which includes a public wireless communication network typified by the Internet network, mobile phone network, or the like. In the pickup management system 100 thus configured, the pickup management server 2 and manager terminal 3 form a pickup management apparatus 5 according to the embodiment of the present invention. The pickup management server 2 or manager terminal 3 alone may form the pickup management apparatus 5. The network 4 also includes closed communication networks provided for predetermined management areas, such as wireless LANs or Wi-Fi (Wireless Fidelity) (Registered Trademark).

The pickup worker terminals 1A and 1B are held in clothes pockets, bags, pouches, or the like of the pickup workers A and B who are visiting the pickup destinations, or disposed in the cradles or the like of vehicles 6A and 6B used for pickup. In the present embodiment, smartphones or tablet terminals, mobile phones, PDAs (Personal Digital Assistants), and various types of wearable terminals that are connectable to a public wireless communication network are collectively referred to as the pickup worker terminals 1A and 1B. The pickup worker terminals 1A and 1B have the same configuration. The number of pickup worker terminals may be three or more. The vehicles 6A and 6B are transportation vehicles, such as four-wheeled vehicles, motorcycles, bicycles, or carts. FIG. 1 shows a light truck (e.g., a light truck having a predetermined displacement or less) 6A, which is widely being used to pick up and deliver cargoes or mails, and a motorized bicycle (e.g., a motorcycle including a motor having a predetermined displacement or less) 6B as an example.

Next, the configuration of the pickup worker terminals 1A and 1B, pickup management server 2, and manager terminal 3 will be described.

### <Pickup Worker Terminals 1A, 1B>

First, the pickup worker terminals 1A and 1B will be described. Various types of application software can be installed on the pickup worker terminals 1A and 1B. The pickup worker terminals 1A and 1B form a part of the pickup management system in accordance with application software installed in smartphones.

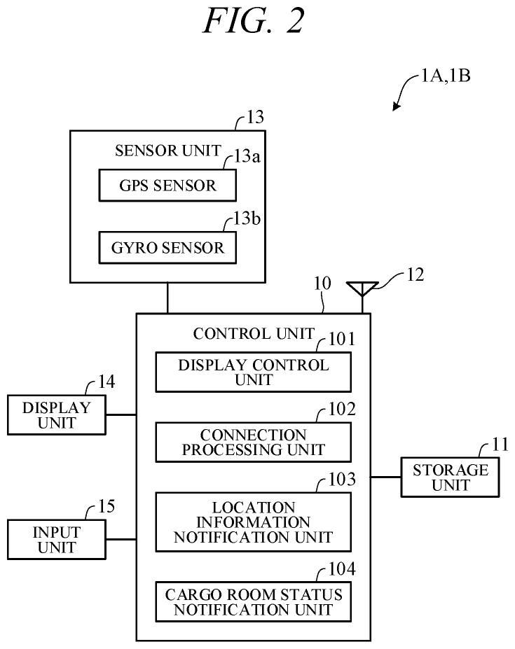

FIG. 2 is a block diagram showing a schematic configuration of the pickup worker terminals 1A and 1B. As shown in FIG. 2, the pickup worker terminal 1A includes a control unit 10, a storage unit 11, a wireless unit 12, a sensor unit 13, a display unit 14, and an input unit 15.

The storage unit 11 consists of a semiconductor memory, hard disk, or the like. The storage unit 11 stores various types of information, such as software including an operating system (OS) and application programs for supporting pickup work, map information, such as road maps and residential maps, and customer information about pickup destinations. The customer information includes the addresses and phone numbers of the pickup destinations, as well as customer-related information, such as whether the customers have delivery boxes. The software, map information, and customer information may be previously stored in the storage unit 11, or acquired from the pickup management server 2. The storage unit 11 also stores information including the addresses (addresses, latitudes, longitudes), phone numbers, designated time slots, and the like of the daily pickup destinations previously assigned to the pickup workers A and B corresponding to the pickup worker terminals 1A and 1B.

The wireless unit 12 includes a digital signal processor (SP) and the like and is configured to be able to wirelessly communicate with the pickup management server 2 through the wireless communication network typified by a mobile phone network, such as 3G, LTE, 4G, or 5G. The wireless unit 12 may include a near-field wireless communication unit (not shown) capable of using a near-field wireless communication technology, such as Wi-Fi (Registered Trademark) or Bluetooth (Registered Trademark). The wireless unit 12 is able to transmit a login ID for identifying the pickup worker A or B (pickup worker ID), information indicating the current location of the pickup worker A or B or vehicle 6A or 6B, the cargo room status, and the like to the pickup management server 2 and to receive spot pickup order information and the like from the pickup management server 2.

The sensor unit 13 includes a GPS sensor 13a that receives locating signals from multiple GPS satellites and measures the absolute location (latitude, longitude) of the pickup worker A or B corresponding to the pickup worker terminal 1A or 1B and a gyro sensor 13b that detects the angular velocity, and the like. The current location may be calculated on the basis of information about the base stations of the wireless communication network acquired from the wireless unit 12. The travel speed of the vehicle 6A or 6B (vehicle speed) may be calculated on the basis of time-series changes in the location information acquired by the GPS sensor 13a. If it is difficult to receive locating signals from the GPS satellites, the current location of the pickup worker A or B or vehicle 6A or 6B may be calculated using Assisted Global Positioning System (AGPS) communication on the basis of the base station information acquired from the wireless unit 12.

The display unit 14 consists of a display device, such as a liquid crystal display or organic EL panel. The display unit 14 receives an instruction from the control unit 10 and displays a map, a button icon for operating a touchscreen, or the like. The display unit 14 also displays various types of information, such as the current location of the pickup worker A or B or vehicle 6A or 6B, a map around the current location, and a map around the pickup destination. The display unit 14 is also able to display the daily pickup destinations stored in the storage unit 11 or a time-series list of spot pickup order information acquired from the pickup management server 2.

The input unit 15 consists of a physical switch, such as a numeric keypad operated by the pickup worker A or B, an input device (not shown), such as a touchscreen disposed so as to be overlaid on the display surface of the display unit 14, or the like. The input unit 15 outputs a signal based on operation input, such as depression of the numeric keypad or touchscreen by the pickup worker A or B, to the control unit 10. Thus, for example, the screen display of the display unit 14 is changed.

Although not shown, the pickup worker terminals 1A and 1B may further include a speaker, vibrator, light, microphone, and the like. The speaker, vibrator, or light notifies the pickup worker of various types of information through a sound, vibration, or light. The speaker outputs a sound to the pickup worker, and the microphone collects a sound or the like issued from the pickup worker. Thus, various types of information is outputted from the speaker in the form of a sound, and various types of commands inputted in the form of a sound through the microphone by the pickup worker are inputted to the control unit 10 using a sound recognition technology.

The control unit 10 includes a processor having a CPU, RAM, ROM, I/O or the like. The CPU performs prestored programs and transmits and receives signals to and from the storage unit 11, the wireless unit 12, the sensor unit 13, the display unit 14, and the input unit 15. The control unit 10 has a display control unit 101, a connection processing unit 102, a location information notification unit 103, and a cargo room status notification unit 104, as a functional configuration.

The display control unit 101 generates an image signal in response to an operation on the input unit 15 or in response to the wireless unit 12 receiving spot pickup order information or the like and transmits the image signal to the display unit 14. Thus, the screen display on the display unit 14 is controlled. The screens that the display control unit 101 causes the display unit 14 to display include a login screen for logging in to the pickup management system 100, a cargo room status screen for inputting the loading status of the cargo room of the vehicle 6A or 6B and transmitting the loading status to the pickup management server 2, an order check screen for displaying spot pickup order information received from the pickup management server 2, and the like. When the display control unit 101 receives spot pickup order information from the pickup management server 2 through the wireless unit 12, it generates an image signal for displaying the order check screen and transmits the image signal to the display unit 14. At this time, the display control unit 101 may further transmit a notification command to the speaker, vibrator, or light to notify the pickup worker of various types of information through a sound, vibration, or light.

The connection processing unit 102 transmits, to the pickup management server 2 through the wireless unit 12, a login ID and a password inputted by the pickup worker A or B on the login screen displayed on the display unit 14 through the input unit 15. Thus, the pickup worker terminal 1A or 1B is communicatively connected to the pickup management server 2. The pickup worker performs this login input when starting to work, that is, when departing from the distribution center. When logout is inputted through the input unit 15, the connection processing unit 102 transmits the logout to the pickup management server 2 through the wireless unit 12. Thus, the communication connection between the pickup worker terminal 1A or 1B and pickup management server 2 is complete. The pickup worker performs this logout input when finishing work, that is, when returning to the distribution center. Logout may be automatically performed on the basis of the time or location information when the pickup worker returns to the distribution center.

The location information notification unit 103 transmits current location information of the pickup worker A or B or vehicle 6A or 6B moving with the pickup worker terminal 1A or 1B calculated on the basis of the signals from the sensor unit 13 (GPS sensor 13a), current time information acquired from a clocking unit (not shown), and the like to the pickup management server 2 through the wireless unit 12 at predetermined time intervals (e.g., at intervals of 3 s) such that these pieces of information are associated with the pickup worker ID. The time information includes not only the time but also information, such as year, month, and date. The pickup management server 2 may calculate the moving speed or moving direction of the pickup worker or vehicle from time-series changes in the location information of the vehicle.

The positions of the vehicles 6A and 6B change from moment to moment. For this reason, when current location information is acquired at predetermined time intervals, the position obtained from the latest current location information and the actual position may not exactly match each other. However, the deviation is small and therefore the location obtained from current location information acquired at predetermined time intervals can be considered as the current location. Multiple pieces of information, such as current location information of the pickup worker A or B or vehicle 6A or 6B acquired at predetermined time intervals and current time information may be collectively transmitted at once (so-called “burst transmission”). The time intervals at which current location information of the pickup worker or vehicle is acquired (e.g., time intervals of 3 s), the number of pieces of information transmitted at once when burst-transmitting multiple pieces of information collectively, or the like may be previously set.

When cargo room information is inputted on the cargo room status screen displayed on the display unit 14 through the input unit 15, the cargo room status notification unit 104 transmits the cargo room status to the pickup management server 2 through the wireless unit 12 such that the cargo room status is associated with the pickup worker ID. Multiple statuses, such as a status in which the cargo room is full and further cargoes are unacceptable (100%), a status in which another several cargoes are acceptable (90%), a status in which there is still an allowance (60%), and a status in which the cargo room is almost vacant (30%), are displayed so as to be selectable as the cargo room status.

### <Pickup Management Server 2>

Next, the pickup management server 2 will be described. While, in the present embodiment, the pickup management server 2 is described as a single server having various functions, it may be a distributed server consisting of servers having different functions or may be realized by a cloud server (virtual server).

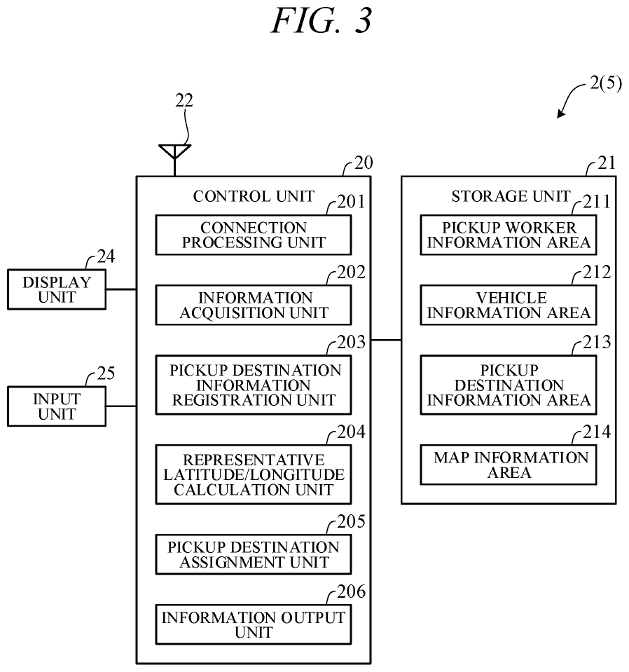

FIG. 3 is a block diagram showing a schematic configuration of the pickup management server 2. As shown in FIG. 3, the pickup management server 2 includes a control unit 20, a storage unit 21, a communication unit 22, a display unit 24, and an input unit 25. The display unit 24 and input unit 25 may be omitted, or may consist of other information terminals (not shown) connected to the pickup management server 2.

The storage unit 21 consists of a semiconductor memory, hard disk, or the like. The storage unit 21 stores various types of information, such as software including an operating system (OS) and application programs. Various storage areas, such as a pickup worker information area 211, a vehicle information area 212, a pickup destination information area 213, a map information area 214, are ensured in the storage unit 21. An information area is, for example, a table in a database management system, or the like.

Pickup worker information used to manage each pickup worker, such as the name of the pickup worker, the ID of the center to which the pickup worker belongs, and the workable time, is stored in the pickup worker information area 211 so as to be associated with the employee ID (pickup worker ID) of the pickup worker, which is identification information of the pickup worker. A vehicle ID, which is identification information of the vehicle 6A or 6B, is also stored in the pickup worker information area 211 so as to be associated with each pickup worker ID. For example, the manager of the distribution center previously sets the association of the vehicle ID with the pickup worker ID before starting daily pickup management work.

Information about each vehicle, including the vehicle type, such as four-wheeled vehicle, motorcycle, or bicycle, and the size of the cargo room, is previously stored in the vehicle information area 212 so as to be associated with the ID of the vehicle. The cargo status received from the pickup worker terminal 1A or 1B is also stored in the vehicle information area 212.

Daily pickup destination information, including the addresses (addresses, latitudes, longitudes), phone numbers, and designated time slots of the daily pickup destinations and the pickup workers A and B assigned to the pickup destinations, is previously stored in the pickup destination information area 213. Spot pickup order information, including the addresses (addresses, latitudes, longitudes), phone numbers, pickup details, and designated time slots of spot pickup destinations newly received from the manager terminal 3 is also stored in the pickup destination information area 213. Also, when a spot pickup order is assigned to the pickup worker A or B, information, such as the pickup worker ID of the assigned pickup worker A or B and the vehicle ID of the vehicle 6A or 6B, is stored in the pickup destination information area 213.

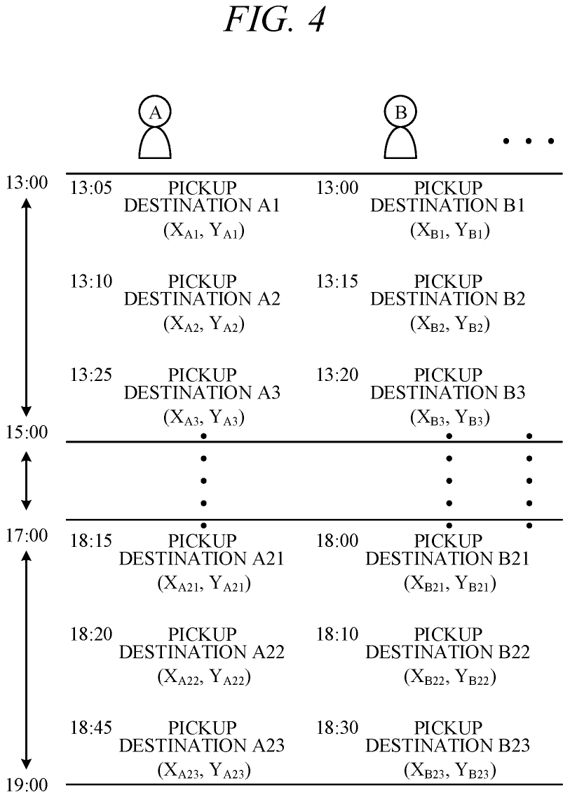

FIG. 4 is a diagram showing an example of pickup destination information managed by the pickup management server 2. As shown in FIG. 4, information about the daily pickup destinations previously assigned to the pickup workers A and B is previously stored in the pickup destination information area 213 and managed for each pickup worker and for each time slot.

Map information is previously stored in the map information area 214. The map information includes road link information, map data for displaying the background, such as roads and road maps, information about road types (general road, highway), and the like. Such map information is updated periodically.

To communicate with the pickup worker terminals 1A and 1B, the communication unit 22 implements a communication protocol capable of wireless communication, such as 3G, LTE, 4G, or 5G. On the other hand, to communicate with the manager terminal 3, the communication unit 22 implements a communication protocol capable of wired communication (e.g., Internet line or the like) or wireless communication.

The control unit 20 includes a processor having a CPU, RAM, ROM, I/O or the like. The control unit 20 has a connection processing unit 201, an information acquisition unit 202, a pickup destination information registration unit 203, a representative latitude/longitude calculation unit 204, a pickup destination assignment unit 205, and an information output unit 206, as a functional configuration.

The connection processing unit 201 processes login from the pickup worker terminal 1A or 1B and connects the pickup worker terminal 1A or 1B to the pickup management server 2, as well as processes logout from the pickup worker terminal 1A or 1B and completes the connection between the pickup worker terminal 1A or 1B and the pickup management server 2. The connection processing unit 201 also processes login from the manager terminal 3 and connects the manager terminal 3 to the pickup management server 2, as well as processes logout from the manager terminal 3 and completes the connection between the manager terminal 3 and pickup management server 2.

The information acquisition unit 202 acquires various types of information by receiving data transmitted from the pickup worker terminals 1A and 1B to the pickup management server 2 and data transmitted from the manager terminal 3 to the pickup management server 2, through the communication unit 22. The information acquired by the information acquisition unit 202 includes location information of the pickup workers A and B or vehicles 6A and 6B transmitted from the location information notification units 103 of the pickup worker terminals 1A and 1B and time information corresponding to the location information, the cargo statuses of the vehicles 6A and 6B transmitted from the cargo room status notification units 104, spot pickup order information transmitted from the manager terminal 3, and the like.

The pickup destination information registration unit 203 registers or modifies a pickup destination data record in the pickup destination information area 213. Specifically, when the pickup destination information registration unit 203 receives information indicating the registration or modification of daily pickup destination information from the manager terminal 3, it registers or modifies the daily pickup destination information in the pickup destination information area 213 on the basis of that information. Also, when a spot pickup order is assigned to the pickup worker A or B, the pickup destination information registration unit 203 adds information about the assigned pickup worker A or B (pickup worker ID) to the pickup destination information area 213.

As shown in FIG. 4, the daily pickup destination information previously stored in the pickup destination information area 213 is managed for each pickup worker (pickup worker ID) and for each pickup time slot. The pickup time slots are time slots predetermined for each distribution center, and spot pickup orders to each distribution center are also received using similar time slots. Specifically, as shown in FIG. 4, location information is represented by a latitude X and a longitude Y.

The representative latitude/longitude calculation unit 204 calculates the representative location of each pickup worker in each pickup time slot on the basis of the daily pickup destination information previously stored in the pickup destination information area 213. The term “representative location” refers to the representative location of each pickup worker visiting in each time slot and can be calculated, for example, as the averages (arithmetic means) of the latitudes and longitudes of daily pickup destinations that each pickup worker is scheduled to visit in each time slot. If weighting is performed in accordance with a predicted stay time for each daily pickup destination, the traffic situation around the daily pickup destination, and the like, the representative location may be calculated as a weighted average. Information indicating the representative location calculated by the representative latitude/longitude calculation unit 204 is stored in the pickup destination information area 213.

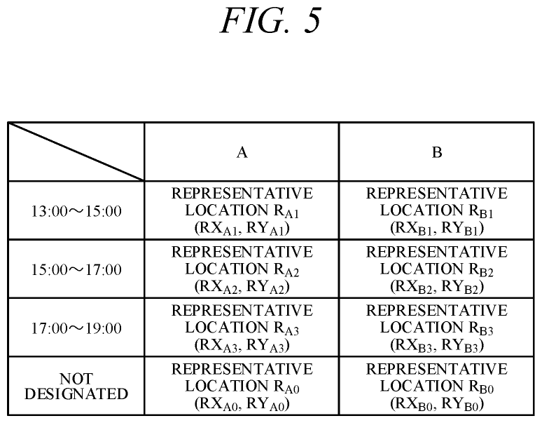

FIG. 5 is a conceptual diagram showing representative locations managed by the pickup management server 2. As shown in FIG. 5, the representative latitude/longitude calculation unit 204 calculates the representative location (representative latitude RX, representative longitude RY) in each pickup time slot for each of the pickup workers A and B. Information indicating the representative location (RX, RY) calculated by the representative latitude/longitude calculation unit 204 is added to the pickup destination information area 213. The representative latitude RX and representative longitude RY in each pickup time slot are calculated as the averages of the latitudes X and longitudes Y of all the daily pickup destinations in the pickup time slot. For example, the representative latitude RXA1 of the pickup worker A in the pickup time slot 13:00 to 15:00 is calculated as the average of the latitudes XA1, XA2, XA3, and the like of the pickup destinations A1, A2, A3, and the like of FIG. 4.

If the pickup time slot is not designated, the representative latitude/longitude calculation unit 204 calculates the average of the representative locations in all the pickup time slots as the representative location. Each time daily pickup destination information is registered or modified, the representative latitude/longitude calculation unit 204 modifies the representative location in the corresponding pickup time slot and, if the pickup time slot is not designated, calculates the representative location (through all the pickup time slots). Thus, the latest representative location is always stored in the pickup destination information area 213 and therefore the pickup destination assignment unit 205 (to be discussed later) is able to make an improved response in its process.

The pickup destination assignment unit 205 assigns a spot pickup order to the pickup worker A or B on the basis of the information stored in the pickup destination information area 213. Specifically, the pickup destination assignment unit 205 first selects one pickup worker whose representative location (RX, RY) calculated by the pickup destination information registration unit 203 in the designated time slot of that spot pickup order is closest to the address (address, latitude, longitude) of the spot pickup destination, or selects multiple pickup workers (candidate pickup workers) in the descending order of such closeness. For example, the pickup destination assignment unit 205 selects the pickup workers A and B as candidate pickup workers. Information indicating the selected candidate pickup workers A and B is transmitted to the manager terminal 3.

Referring to the information indicating the candidate pickup workers A and B transmitted from the pickup management server 2, the manager designates a pickup worker to which the spot pickup order is to be assigned (assigned pickup worker), through the manager terminal 3. Or, without relying on a command of the manager, the manager terminal 3 automatically designates an assigned pickup worker in accordance with a predetermined criterion. For example, the manager terminal 3 designates, as an assigned pickup worker, a pickup worker whose representative location (RX, RY) is closest to the address (address, latitude, longitude) of the spot pickup destination. The pickup destination assignment unit 205 finally determines a pickup worker to which the spot pickup order is to be assigned, in accordance with the designation of the pickup worker by the manager or manager terminal 3. Thus, even if the manager who assigns pickup work at the distribution center is inexperienced or even if no manager is present at the distribution center, the pickup worker who will visit the spot pickup destination can be efficiently determined.

When selecting between the candidate pickup workers A and B, the pickup destination assignment unit 205 may exclude a pickup worker who is unable to undertake the spot pickup order, on the basis of the types and cargo room statuses of the vehicles 6A and 6B stored in the vehicle information area 212, pickup details included in the spot pickup order information stored in the pickup destination information area 213, and the like. The pickup destination assignment unit 205 may exclude a pickup worker who has not transmitted location information for a predetermined time (e.g., 3 min) or more. The number of candidate pickup workers selected by the pickup destination assignment unit 205, or the like may be previously set. The number of candidate pickup workers may be previously set to one, and the pickup management server 2 may determine a candidate pickup worker without transmitting information indicating the candidate pickup worker to the manager terminal 3.

After the pickup destination assignment unit 205 assigns the spot pickup order to the pickup worker A or B, the representative latitude/longitude calculation unit 204 may calculate (update) the representative location in the designated time slot of the pickup worker to which the spot pickup order has been assigned and, if the pickup time slot is not designated, may calculate the representative location. In this case, the representative latitude/longitude calculation unit 204 may calculate the representative location in the designated time slot of the spot pickup order as the averages of the latitudes X and longitudes Y of all the daily pickup destinations in that designated time slot and the newly assigned spot pickup destination. Thus, the representative location of the pickup worker A managed by the pickup management server 2 becomes a more accurate location.

The information output unit 206 outputs various types of information by transmitting data from the pickup management server 2 to the pickup worker terminals 1A and 1B and manager terminal 3 through the communication unit 22. For example, the information output unit 206 transmits information indicating the selected candidate pickup workers A and B to the manager terminal 3 and transmits the spot pickup order information to the pickup worker terminal 1A or 1B of the pickup worker A or B to which the spot pickup order has been assigned.

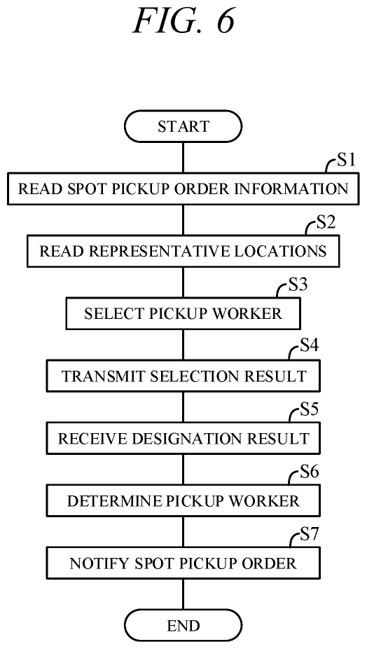

FIG. 6 is a flowchart showing an example of process performed by the CPU of the pickup management server 2 in accordance with a program stored in advance. The process shown in the flow chart is started, for example, when the spot pickup order information is received from the manager terminal 3.

First, in step S1, the information acquisition unit 202 reads the spot pickup order information received from the manager terminal 3 through the communication unit 22. Next, in step S2, the pickup destination assignment unit 205 reads the representative locations in designated time slots of the spot pickup order calculated by the pickup destination assignment unit 205 and stored in the pickup destination information area 213. Next, in step S3, the pickup destination assignment unit 205 selects one pickup worker whose representative location is closest to the address of the spot pickup destination or selects multiple pickup workers in the descending order of such closeness. Specifically, the pickup destination assignment unit 205 selects the pickup workers as candidate pickup workers. Next, in step S4, the information output unit 206 transmits the selection result of the pickup workers to the manager terminal 3. With this, the assigned pickup worker is designated on the manager terminal 3 side.

Next, in step S5, the information acquisition unit 202 receives the designation result of the pickup worker (assigned pickup worker) received from the manager terminal 3 through the communication unit 22. Next, in step S6, the pickup destination assignment unit 205 finally determines a pickup worker to which the spot pickup order is to be assigned, in accordance with the designation result of the pickup worker received in step S5. In this manner, the pickup management server 2 determines the candidate pickup workers (step S3), and the manager terminal 3 finally determines the assigned pickup worker, thereby making it possible to determine the optimum assigned pickup worker in consideration of various circumstances. For example, when there is driving evaluation information that evaluates the driving of the vehicle by the pickup worker, it is possible to determine the optimum assigned pickup worker based on the driving evaluation information. In addition, the optimum assigned pickup worker may be determined in accordance with the traffic situation around the spot pickup destination. Next, in S7, the information output unit 206 transmits the spot pickup order information to the pickup worker terminal 1A or 1B of the pickup worker A or B to which the spot pickup order is assigned. As a result, the pickup worker A or B recognizes the spot pickup request and performs the spot pickup together with the daily pickup.

### <Manager Terminal 3>

Next, the manager terminal 3 will be described. The manager terminal 3 is used by the manager of the distribution center in order to manage the pickup workers who are visiting the pickup destinations. The manager terminal 3 is any type of computer, such as a personal computer, tablet terminal, or smartphone, disposed in the distribution center and transmits and receives information to and from the pickup management server 2 through the network 4.

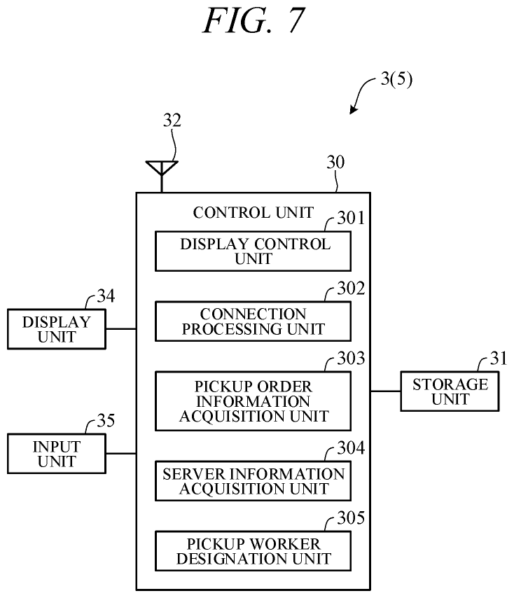

FIG. 7 is a block diagram showing a schematic configuration of the manager terminal 3. As shown in FIG. 7, the manager terminal 3 includes a control unit 30, a storage unit 31, a communication unit 32, a display unit 34, and an input unit 35.

The storage unit 31 consists of a semiconductor memory, hard disk, or the like. The storage unit 31 stores various types of information, such as software including an operating system (OS) and application programs.

The communication unit 32 implements a communication protocol capable of wired communication (e.g., the Internet line or the like) or wireless communication, such as 3G, LTE, 4G, or 5G, and is connected to the pickup management server 2 to transmit and receive various types of data to and from the pickup management server 2.

The display unit 34 consists of a display device, such as a liquid crystal display or organic EL panel. Upon receipt of an instruction from the control unit 30, the display unit 34 displays a map, a button icon for operating a touchscreen, or the like.

The display unit 34 is also able to display the candidate pickup workers A and B to one of which the spot pickup order is to be assigned, on the basis of the information transmitted from the information output unit 206 of the pickup management server 2 (the information transmitted in step S4) (pickup worker designation screen).

FIG. 8 is a diagram showing an example of the pickup worker designation screen. As shown in FIG. 8, a pickup worker designation screen DP1 is displayed as a modal window. The name, address, phone number, pickup details, and designated time slot of a spot pickup destination are displayed in an order details display section DP2, which is an upper portion of the pickup worker designation screen DP1. The candidate pickup workers A and B selected by the pickup management server 2 are displayed in the descending order of the closeness of the representative location to the address of the spot pickup destination in a pickup worker designation section DP3, which is a lower portion of the pickup worker designation screen DP1. Checkboxes are also displayed in the pickup worker designation section DP3 so as to correspond to the displayed pickup workers.

The input unit 35 consists of physical switches, such as a numeric keypad operated by the manager, an input device (not shown), such as a touchscreen, disposed so as to be overlaid on the display surface of the display unit 34, or the like. A command to change the screen display on the display unit 34 is inputted through the input unit 35. The assigned pickup worker is designated through the input unit 35. That is, a selection command is inputted to a check box on the pickup worker designation screen of FIG. 8 through the input unit 35.

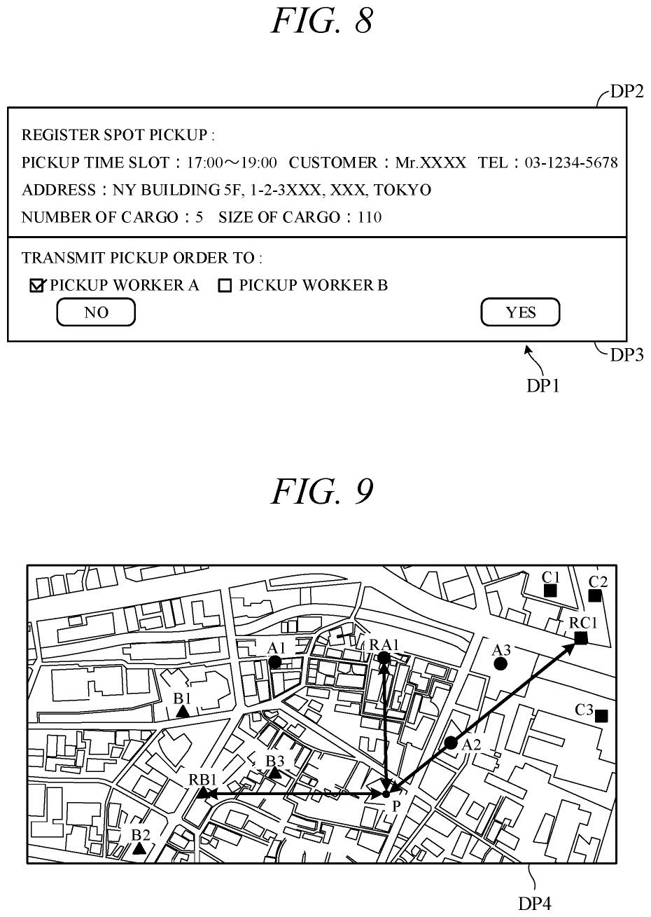

FIG. 9 is a diagram showing another example of the pickup worker designation screen. As shown in FIG. 9, a map around a spot pickup destination P, including the representative locations RA1 and RB1 of the candidate pickup workers A and B, is displayed on a pickup worker designation screen DP4. An assigned pickup worker is designated by depressing the representative location RA1 or RB1 on the pickup worker designation screen DP4 of FIG. 9 through the input unit 35 (touchscreen). The pickup worker designation screen DP1 of FIG. 8 consisting of a modal window may be displayed so as to be overlaid on the pickup worker designation screen DP4 of FIG. 9 displaying a map. Displaying the pickup worker designation screen as a map allows the manager who designates a pickup worker to intuitively grasp the situation around the pickup workers and spot pickup destination P.

The control unit 30 includes a processor having a CPU, RAM, ROM, I/O or the like. The control unit 30 has a display control unit 301, a connection processing unit 302, a pickup order information acquisition unit 303, a server information acquisition unit 304, and a pickup worker designation unit 305, as a functional configuration.

The display control unit 301 controls the screen display on the display unit 34 by generating an image signal in response to an operation on the input unit 35 or in response to the communication unit 32 receiving information indicating the selected candidate pickup workers, or the like and transmitting the image signal to the display unit 34. The screens that the display control unit 301 causes the display unit 34 to display include a login screen for logging in to the pickup management system 100, an order input screen for inputting spot pickup order information and transmitting the information to the pickup management server 2, a pickup worker designation screen for displaying information indicating the selected candidate pickup workers received from the pickup management server 2, and the like.

The connection processing unit 302 processes login to the pickup management server 2 using, for example, an identification number for identifying the distribution center (manager or person in charge) (center manager ID) and a password.

The pickup order information acquisition unit 303 acquires spot pickup order information received from a customer through the counter of the distribution center, a phone call, the Internet, or the like and inputted through the input unit 35 by the manager, and stored in the storage unit 31. The pickup order information acquisition unit 303 then transmits the spot pickup order information to the pickup management server 2 through the communication unit 32. The spot pickup order information includes the address (address, latitude, longitude), phone number, pickup details, designated time slot, and the like of the spot pickup destination.

The server information acquisition unit 304 acquires information transmitted from the pickup management server 2 (information output unit 206 or the like) in accordance with a request from the manager terminal 3, for example, information indicating the selected candidate pickup workers A and B to one of which the spot pickup order is to be assigned.

The pickup worker designation unit 305 designates the pickup worker A of the candidate pickup workers A and B selected by the pickup management server 2, as an assigned pickup worker to which the spot pickup order is to be assigned, in accordance with a command from the manager. For example, the pickup worker designation unit 305 designates, as an assigned pickup worker, a pickup worker designated through the input unit 35 on the basis of information indicating the driving evaluation of the pickup workers, the traffic situation around the spot pickup destination, and the like. The number of assigned pickup workers designated by the pickup worker designation unit 305 need not be one and may be two or more. Information indicating the assigned pickup worker designated by the pickup worker designation unit 305 is transmitted to the pickup management server 2 through the communication unit 32. If no assigned pickup worker is designated within a predetermined time, an assigned pickup worker may automatically be designated in accordance with a predetermined criterion.

### <Operation of Pickup Management System 100>

Next, an example of the operation of the pickup management system 100 will be described. Hereafter, the operation of the pickup management apparatus 100 that handles not only the pickup workers A and B of FIG. 1 but also a pickup worker C will be described. The pickup worker C also has a pickup worker terminal 1C similar to those of the pickup workers A and B. Daily pickup destinations as shown in FIG. 9 are previously assigned to the pickup workers A to C. Specifically, as the daily pickup destinations, A1 to A3 are assigned to the pickup worker A, B1 to B3 to the pickup worker B, and Cl to C3 to the pickup worker C.

For example, when starting from the distribution center, that is, when starting work, the pickup workers A to C input their login IDs and passwords on the login screens displayed on the display units 14 of the pickup worker terminals 1A to 1C through the input units 15. The pickup management server 2 processes connection from the pickup worker terminals 1A to 1C. Subsequently, the pickup worker terminals 1A to 1C communicate with the pickup management server 2 at predetermined time intervals (e.g., at intervals of 3 s), for example, transmit location information of the pickup workers A to C to the pickup management server 2. The communication between the pickup worker terminals 1A to 1C and pickup management server 2 continues until the pickup worker terminals 1A to 1C log out.

On the other hand, the manager of the distribution center inputs the center manager ID and password on the login screen displayed on the display unit 34 of the manager terminal 3 through the input unit 35. The pickup management server 2 processes connection from the manager terminal 3. The manager receives a spot pickup order from a customer through the counter of the distribution center, a phone call, the Internet, or the like and inputs spot pickup order information on the order input screen of the manager terminal 3. In response to this input, the pickup management server 2 selects candidate pickup workers, for example, two pickup workers A and B, in the descending order of the closeness of the representative location (e.g., RA1, RB1, RC1 of FIG. 9) in the time slot designated in the spot pickup order to the address of the spot pickup destination (e.g., P of FIG. 9). The pickup management server 2 transmits information indicating the selected candidate pickup workers to the manager terminal 3 (steps S1 to S4).

The manager terminal 3 receives the information indicating the selected candidate pickup workers A and B from the pickup management server 2 and displays the pickup worker designation screen DP1 or DP4 including this information on the display unit 34 (FIGS. 8 and 9). The manager designates an assigned pickup worker, for example, designates the pickup worker A as an assigned pickup worker by operating a checkbox on the pickup worker designation screen DP1 through the input unit 35 (touchscreen) or depressing a representative location on a pickup worker designation screen DP7. The manager terminal 3 transmits information indicating the designated pickup worker to the pickup management server 2 (step S5). The pickup management server 2 receives the information indicating the designated pickup worker A from the manager terminal 3, determines the pickup worker A as a pickup worker to which the spot pickup order is to be assigned, and transmits the spot pickup order information to the pickup worker terminal 1A of the pickup worker A (steps S6 and S7).

The pickup worker terminal 1A receives the spot pickup order information from the pickup management server 2 and displays this information on the display unit 14. At this time, the pickup worker terminal 1A notifies the pickup worker A that it has received the spot pickup order information, for example, by vibrating itself. Thus, the pickup worker A is allowed to undertake the spot pickup order of the pickup destination close to a daily pickup destination previously assigned to himself or herself, that is, efficiently perform pickup work.

When the spot pickup order is assigned to the pickup worker A, the pickup management server 2 may update the representative location of the pickup worker A in the designated time slot of the spot pickup order. Thus, the representative location of the pickup worker A managed by the pickup management server 2 becomes a more accurate location. If the customer who has ordered the above spot pickup places an additional spot order in the same designated time slot, the representative location of the pickup worker A to which the above spot pickup order has been assigned is already updated as a location closer to this spot pickup destination. Thus, the possibility that the additional spot pickup order also will be assigned to the same pickup worker A is increased, allowing the pickup worker A to perform pickup work more efficiently.

The manager of the distribution center is able to designate the pickup worker A as the most suitable pickup worker to which the spot pickup order is to be assigned, from the pickup workers A and B who are visiting the vicinity of the spot pickup destination in the designated time slot of the spot pickup order among the pickup workers A to C. Thus, the man-hours taken to perform a check of the daily pickup courses of the pickup workers, or the like can be reduced. Even if the manager is inexperienced and is not able to grasp approximate locations that the pickup workers are visiting in each pickup time slot, he or she is able to determine a suitable pickup worker to which the spot pickup order is to be assigned, with reference to the pickup workers selected by the pickup management server 2. If the number of pickup workers selected by the pickup management server 2 is previously set to one, the pickup management server 2 is able to determine the pickup worker A as a pickup worker to which the spot pickup order is to be assigned, without having to cause the manager terminal 3 to display the pickup worker designation screen.

That is, according to the present embodiment, the manager of the distribution center only has to input spot pickup order information received through a phone call or the like. Thus, the pickup worker A or B who is closer to the spot pickup destination is selected from the pickup workers who are visiting the daily pickup destinations in the time slot designated in the spot pickup order and displayed on the manager terminal 3. As seen above, even if the manager is inexperienced or even if no manager is present at the distribution center, a pickup worker who will visit the spot pickup destination can be efficiently determined.

The present embodiment can achieve advantages and effects such as the following:

(1) The visit management apparatus 5 is configured to manage assignment of a plurality of pickup workers to pickup destinations. The visit management apparatus 5 includes: the representative latitude/longitude calculation unit 204 configured to calculate representative locations (RX, RY) of latitude and longitude of predetermined daily pickup destinations in the designated time slot for each of the plurality of pickup workers; the information acquisition unit 202 and the pickup order information acquisition unit 303 configured to acquire the spot pickup order information for visiting the additional spot pickup destination other than the predetermined daily pickup destinations in the designated time slot; and the pickup destination assignment unit 205 configured to assign a worker to visit the additional pickup destination based on comparison result between the representative locations (RX, RY) calculated by the representative latitude/longitude calculation unit 204 and latitude and longitude of the additional spot pickup destination, when the spot pickup order information for visiting the additional spot pickup destination is acquired by the information acquisition unit 202 and the pickup order information acquisition unit 303 (FIG. 3, FIG. 7).

With this configuration, it becomes possible to efficiently assign a pickup worker to visit the spot pickup destination from among the plurality of pickup workers traveling around daily pickup destinations in the time slot designated in the spot pickup order. With this, it becomes possible to reduce the man-hours required for the manager who has received the spot pickup order at the distribution center to check the daily pickup courses of the pickup worker.

(2) The representative latitude/longitude calculation unit 204 is configured to calculate average values of latitude and longitude of the predetermined daily pickup destinations in the designated time slot as the representative locations (RX, RY). The pickup destination assignment unit 205 is configured to assign the pickup worker for whom the average location (RX, RY) calculated by the representative latitude/longitude calculation unit 204 is closest to the latitude and longitude of the additional spot pickup destination. With this, it becomes possible to automatically assign pickup workers even when there is no manager in the distribution center.

(3) The representative latitude/longitude calculation unit 204 is configured to calculate average values of latitude and longitude of the predetermined daily pickup destinations in the designated time slot as the representative locations (RX, RY). The pickup destination assignment unit 205 is configured to select a predetermined number of candidate pickup workers in descending order of closeness from the representative locations (RX, RY) calculated by the representative latitude/longitude calculation unit 204 to the latitude and longitude of the additional spot pickup destination. The visit management apparatus 5 further includes: the pickup worker designation unit 305 configured to designate the pickup worker to visit the additional spot pickup destination from among the candidate pickup workers selected by the pickup destination assignment unit 205 (FIG. 7). The pickup destination assignment unit 205 is configured to assign the pickup worker designated by the pickup worker designation unit 305. With this configuration, multiple pickup workers suitable to be assigned the spot pickup order are selected on the pickup management server 2 side, and the manager who manages the pickup at the distribution center can designate the pickup worker to be actually assigned the spot pickup order in consideration of various circumstances.

(4) The visit management apparatus 5 further includes: the output unit 206 configured to output notification command to notify that the pickup worker assigned by the pickup destination assignment unit 205 is to visit the additional spot pickup destination (FIG. 3). With this configuration, it becomes possible to transmit the spot pickup order information to the pickup worker terminals 1A, 1B of the pickup workers assigned the spot pickup order, and to notify the spot pickup order information to the pickup worker through the display unit 14 or the like of the pickup worker terminal 1A, 1B.

(5) The representative latitude/longitude calculation unit 204 is further configured to further calculate a representative location (RX, RY) for the pickup worker to visit the additional spot pickup destination assigned by the pickup destination assignment unit 205 using latitude and longitude of the additional spot pickup destination, when the pickup worker is assigned by the pickup destination assignment unit 205. With this, the representative location of the pickup worker A managed by the pickup management server 2 becomes more accurate.

(6) The pickup management system 100 includes: the pickup management server 2 configured to manage assignment of a plurality of pickup workers to pickup destinations; and a plurality of pickup worker terminals 1A, 1B respectively carried by the plurality of pickup workers (FIG. 1). The management server 2 includes: the representative latitude/longitude calculation unit 204 configured to calculate representative locations (RX, RY) of latitude and longitude of predetermined daily pickup destinations in a designated time slot for each of the plurality of pickup workers; the information acquisition unit 202 configured to acquire spot pickup order information for visiting an additional spot pickup destination other than the predetermined daily pickup destinations in the designated time slot; the pickup destination assignment unit 205 configured to assign a pickup worker to visit the additional spot pickup destination based on comparison result between the representative locations (RX, RY) calculated by the representative latitude/longitude calculation unit 204 and latitude and longitude of the additional spot pickup destination, when the spot pickup order information for visiting the additional spot pickup destination is acquired by the information acquisition unit 202; and the information output unit 206 configured to transmit notification command to notify that the pickup worker assigned by the pickup destination assignment unit 205 is to visit the additional spot pickup destination, to the pickup worker terminal 1A, 1B of the pickup worker assigned by the pickup destination assignment unit 205 (FIG. 3). The pickup worker terminal 1A, 1B includes: the display unit 14 configured to make notification in accordance with the notification command transmitted by the information output unit 206 (FIG. 2). With this, it becomes possible to efficiently determine the pickup worker to visit the spot pickup destination from among the pickup workers traveling around the daily pickup destinations in the time slot designated in the spot pickup order, and to notify the spot pickup order information to the pickup worker through the display unit 14 of the pickup worker terminal 1A, 1B.

(7) The visit management system 100 further includes: the manager terminal 3 manipulatable by the manager managing assignment of the plurality of pickup workers to pickup destinations (FIG. 1). The representative latitude/longitude calculation unit 204 is configured to calculate average values of latitude and longitude of the predetermined daily pickup destinations in the designated time slot as the representative locations (X, Y). The pickup destination assignment unit 205 is configured to select a predetermined number of candidate pickup workers in descending order of closeness from the representative locations (X, Y) calculated by the representative latitude/longitude calculation unit 204 to the latitude and longitude of the additional spot pickup destination. The manager terminal 3 includes: the pickup worker designation unit 305 configured to designate the pickup worker to visit the additional spot pickup destination from among the candidate pickup workers selected by the pickup destination assignment unit 205 in response to manipulation of the manager (FIG. 7). The pickup destination assignment unit 205 is configured to assign the pickup worker designated by the pickup worker designation unit 305. With this, since it becomes possible to select multiple pickup workers suitable to be assigned the spot pickup order on the pickup management server 2 side and to designate from among the selected pickup workers on the manager terminal 3 side, the manager managing the pickup at the distribution center can designate the pickup worker to be actually assigned the spot pickup order in consideration of various circumstances.

The above embodiment can be modified to various forms. Hereinafter, modified examples will be described. In the above embodiment, although the pickup management apparatus 5 is configured to manage assignment of the pickup workers to the pickup destinations, a visit management apparatus configured to manage assignment of workers to visiting destinations can be configured other than the above. For example, the visit management apparatus can be applied to various types of business including delivery of milk and the like by refrigerated vehicles, on-site sales by visitors, and on-site sales by mobile sales vehicles.

In the above embodiment, although the representative latitude/longitude calculation unit 204 calculates representative values of latitude and longitude of the daily pickup destinations, a representative latitude/longitude calculation unit configured to calculate representative values of latitude and longitude can be configured other than the above. Instead of the latitude and longitude, for example, a direction and a distance as seen from the distribution center may be used.

In the above embodiment, although the pickup order information acquisition unit 303 of the manager terminal 3 acquires the spot pickup order information input through the input unit 35 or stored in the storage unit 31 and transmits it to the pickup management server 2, and the information acquisition unit 202 of the pickup management server 2 acquires the transmitted spot pickup order information, an information acquisition unit configured to acquire order information for visiting can be configured other than the above. For example, the information acquisition unit 202 of the pickup management server 2 may directly receive the spot pickup order information transmitted by the spot pickup orderer through his/her smartphone, personal computer, or the like.

In the above embodiment, although the pickup destination assignment unit 205 selects one pickup worker whose representative location (RX, RY) in the designated time slot is closest to the spot pickup destination, or selects multiple candidate pickup workers in the descending order of such closeness, and assigns the spot pickup order to the pickup worker, a worker assignment unit configured to assign a worker to visit the additional visiting destination can be configured other than the above. For example, it is also possible to select a pickup worker for whom the spot pickup destination is included within a predetermined range centered on the representative location (RX, RY) in the designated time slot.

In the above embodiment, although the pickup worker designation unit 305 designates pickup worker A, B to be assigned the spot pickup order from among the pickup worker A, B selected by the pickup management server 2, a worker designation unit configured to designate the worker can be configured other than the above. For example, it is also possible to designate a pickup worker other than the pickup worker A, B selected by the pickup management server 2.

In the above embodiment, although the display unit 14 displays the spot pickup order information, a notification unit configured to make notification can be configured other than the above. For example, the notification can be made by sound and vibration, lighting or flashing of the light, or the like, in addition to the screen display.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1A, 1B pickup worker terminal, 2 pickup management server, 3 manager terminal, 4 network, 5 pickup management apparatus, 6A, 6B vehicle, 10 control unit, 11 storage unit, 12 wireless unit, 13 sensor unit, 13a GPS sensor, 13b gyro sensor, display unit, 15 input unit, 20 control unit, 21 storage unit, 22 communication unit, 24 display unit, 25 input unit, 30 control unit, 31 storage unit, 32 communication unit, 34 display unit, 35 input unit, 100 pickup management system, 101 display control unit, 102 connection processing unit, 103 location information notification unit, 104 cargo room status notification unit, 201 connection processing unit, 202 information acquisition unit, 203 pickup destination information registration unit, 204 representative latitude/longitude calculation unit, 205 pickup destination assignment unit, 206 information output unit, 211 pickup worker information area, 212 vehicle information area, 213 pickup destination information area, 214 map information area, 301 display control unit, 302 connection processing unit, 303 pickup order information acquisition unit, 304 server information acquisition unit, 305 pickup worker designation unit

1. A visit management apparatus configured to manage assignment of a plurality of workers to visiting destinations, comprising:
a microprocessor and a memory coupled to the microprocessor, wherein
the microprocessor is configured to function as:
a representative latitude/longitude calculation unit configured to calculate representative values of latitude and longitude of predetermined visiting destinations in a certain time slot for each of the plurality of workers;
an information acquisition unit configured to acquire order information for visiting an additional visiting destination other than the predetermined visiting destinations in the certain time slot; and
a worker assignment unit configured to assign a worker to visit the additional visiting destination based on a comparison result between the representative values calculated by the representative latitude/longitude calculation unit and latitude and longitude of the additional visiting destination, when the order information for visiting the additional visiting destination is acquired by the information acquisition unit, wherein
the representative latitude/longitude calculation unit is configured to calculate average values of latitude and longitude of the predetermined visiting destinations in the certain time slot as the representative values.

2. The visit management apparatus according to claim 1, wherein
the worker assignment unit is configured to assign the worker for whom the average value calculated by the representative latitude/longitude calculation unit is closest to the latitude and longitude of the additional visiting destination.

3. The visit management apparatus according to claim 1, wherein
the worker assignment unit is configured to select a predetermined number of candidate workers in descending order of closeness from the average values calculated by the representative latitude/longitude calculation unit to the latitude and longitude of the additional visiting destination, wherein
the microprocessor is configured to function as:
a worker designation unit configured to designate the worker to visit the additional visiting destination from among the candidate workers selected by the worker assignment unit, wherein
the worker assignment unit is configured to assign the worker designated by the worker designation unit.

4. The visit management apparatus according to claim 1, wherein
the microprocessor is configured to function as:
an output unit configured to output a notification command to notify that the worker assigned by the worker assignment unit is to visit the additional visiting destination.

5. The visit management apparatus according to claim 1, wherein
the representative latitude/longitude calculation unit is further configured to further calculate a representative value for the worker to visit the additional visiting destination assigned by the worker assignment unit using latitude and longitude of the additional visiting destination, when the worker is assigned by the worker assignment unit.

6. A visit management method for managing assignment of a plurality of workers to visiting destinations, comprising:
a representative latitude/longitude calculation step for calculating representative values of latitude and longitude of predetermined visiting destinations in a certain time slot for each of the plurality of workers;
an order information acquisition step for acquiring order information for visiting an additional visiting destination other than the predetermined visiting destinations in the certain time slot; and
a worker assignment step for assigning a worker to visit the additional visiting destination based on a comparison result between the representative values calculated in the representative latitude/longitude calculation step and latitude and longitude of the additional visiting destination, when the order information for visiting the additional visiting destination is acquired in the order information acquisition step, wherein
the representative latitude/longitude calculation step includes calculating average values of latitude and longitude of the predetermined visiting destinations in the certain time slot as the representative values.

7. A visit management system, comprising:
a management server configured to manage assignment of a plurality of workers to visiting destinations; and
a plurality of portable terminals respectively carried by the plurality of workers, wherein
the management server includes: a microprocessor and a memory coupled to the microprocessor, wherein
the microprocessor is configured to function as:
a representative latitude/longitude calculation unit configured to calculate representative values of latitude and longitude of predetermined visiting destinations in a certain time slot for each of the plurality of workers;
an information acquisition unit configured to acquire order information for visiting an additional visiting destination other than the predetermined visiting destinations in the certain time slot;
a worker assignment unit configured to assign a worker to visit the additional visiting destination based on a comparison result between the representative values calculated by the representative latitude/longitude calculation unit and latitude and longitude of the additional visiting destination, when the order information for visiting the additional visiting destination is acquired by the information acquisition unit; and
a transmission unit configured to transmit a notification command to notify that the worker assigned by the worker assignment unit is to visit the additional visiting destination, to a portable terminal of the worker assigned by the worker assignment unit, wherein
the portable terminal includes:
a notification unit configured to make notification in accordance with the notification command transmitted by the transmission unit, wherein
the representative latitude/longitude calculation unit is configured to calculate average values of latitude and longitude of the predetermined visiting destinations in the certain time slot as the representative values.

8. The visit management system according to claim 7, further comprising:
a management terminal manipulatable by a manager managing assignment of the plurality of workers to visiting destinations, wherein
the worker assignment unit is configured to select a predetermined number of candidate workers in descending order of closeness from the average values calculated by the representative latitude/longitude calculation unit to the latitude and longitude of the additional visiting destination, wherein
the microprocessor is a first microprocessor and the memory is a first memory, wherein
the management terminal includes: a second microprocessor and a second memory coupled to the second microprocessor, wherein
the second microprocessor is configured to function as:
a worker designation unit configured to designate the worker to visit the additional visiting destination from among the candidate workers selected by the worker assignment unit in response to manipulation of the manager, wherein
the worker assignment unit is configured to assign the worker designated by the worker designation unit.

9. A visit management apparatus configured to manage assignment of a plurality of workers to visiting destinations, comprising:
a microprocessor and a memory coupled to the microprocessor, wherein
the microprocessor is configured to perform:
calculating representative values of latitude and longitude of predetermined visiting destinations in a certain time slot for each of the plurality of workers;
acquiring order information for visiting an additional visiting destination other than the predetermined visiting destinations in the certain time slot; and
assigning a worker to visit the additional visiting destination based on a comparison result between the representative values calculated in the calculating and latitude and longitude of the additional visiting destination, when the order information for visiting the additional visiting destination is acquired in the acquiring, wherein the microprocessor is configured to perform:
the calculating including calculating average values of latitude and longitude of the predetermined visiting destinations in the certain time slot as the representative values.

10. The visit management apparatus according to claim 9, wherein
the microprocessor is configured to perform:
the assigning including assigning the worker for whom the average value calculated in the calculating is closest to the latitude and longitude of the additional visiting destination.

11. The visit management apparatus according to claim 9, wherein
the microprocessor is configured to perform:
the assigning including selecting a predetermined number of candidate workers in descending order of closeness from the average values calculated in the calculating to the latitude and longitude of the additional visiting destination, wherein
the microprocessor is configured to perform:
designating the worker to visit the additional visiting destination from among the candidate workers selected in the selecting, wherein
the microprocessor is configured to perform:
the assigning including assigning the worker designated in the designating.

12. The visit management apparatus according to claim 9, wherein
the microprocessor is configured to perform:
outputting a notification command to notify that the worker assigned in the assigning is to visit the additional visiting destination.

13. The visit management apparatus according to claim 9, wherein
the microprocessor is configured to perform:
the calculating including calculating a representative value for the worker to visit the additional visiting destination assigned in the assigning using latitude and longitude of the additional visiting destination, when the worker is assigned in the assigning.

14. A visit management system, comprising:
a management server configured to manage assignment of a plurality of workers to visiting destinations; and
a plurality of portable terminals respectively carried by the plurality of workers, wherein
the management server includes: a microprocessor and a memory coupled to the microprocessor, wherein
the microprocessor is configured to perform:
calculating representative values of latitude and longitude of predetermined visiting destinations in a certain time slot for each of the plurality of workers;
acquiring order information for visiting an additional visiting destination other than the predetermined visiting destinations in the certain time slot;
assigning a worker to visit the additional visiting destination based on a comparison result between the representative values calculated in the calculating and latitude and longitude of the additional visiting destination, when the order information for visiting the additional visiting destination is acquired in the acquiring; and
transmitting a notification command to notify that the worker assigned in the assigning is to visit the additional visiting destination, to a portable terminal of the worker assigned in the assigning, wherein
the portable terminal includes:
a notification unit configured to make notification in accordance with the notification command transmitted in the transmitting, wherein
the microprocessor is configured to perform:
the calculating including calculating average values of latitude and longitude of the predetermined visiting destinations in the certain time slot as the representative values.

16. The visit management system according to claim 15, further comprising:
a management terminal manipulatable by a manager managing assignment of the plurality of workers to visiting destinations, wherein
the microprocessor is a first microprocessor and the memory is a first memory, wherein
the first microprocessor is configured to perform:
the assigning including selecting a predetermined number of candidate workers in descending order of closeness from the average values calculated in the calculating to the latitude and longitude of the additional visiting destination, wherein
the management terminal includes: a second microprocessor and a second memory coupled to the second microprocessor, wherein
the second microprocessor is configured to perform:
designating the worker to visit the additional visiting destination from among the candidate workers selected in the selecting in response to manipulation of the manager, wherein
the first microprocessor is configured to perform:
the assigning including assigning the worker designated in the designating.
